(19) United States
(12) Patent Application Publication
(10) Pub. No.: US 2008/0278750 A1
(43) Pub. Date: Nov. 13, 2008

(54) System And Method For Intelligent Label Printer Control

(76) Inventors: Daniel Adolf Lehotsky, Waterloo (CA); Tsutomu Nobutani, Toronto (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/103,037

(22) Filed: Apr. 15, 2008

Related U.S. Application Data
(60) Provisional application No. 60/917,470, filed on May 11, 2007.

(51) Int. Cl. G06F 15/00

(52) U.S. Cl. 358/1.15

(57) ABSTRACT

Methods and systems for intelligently printing labels based on order data are described. One example method includes receiving order data at a receipt printer. The receipt printer may be communicatively connected to a POS terminal adapted to receive or generate the order data from an operator's entries. The order data may then be transmitted to a label printer and processed at the label printer to generate corresponding label data. The label printer may generate the label data with reference to a plurality of pre-defined templates. In addition to or as part of generating label data, the label printer may also generate customer data based on the order data.

### CROSS-REFERENCE TO RELATED APPLICATIONS

This application claims priority to U.S. Provisional Patent Application Ser. No. 60/917,470, filed on May 11, 2007.

### BACKGROUND

1. The Field of the Invention

The present invention relates to intelligent label printer control. More specifically, embodiments of the present invention relate to methods and systems for intelligently printing labels based on data extracted from a sales transaction.

2. The Relevant Technology

In a sales transaction a customer might place an order at one location and pick up the order at a different location. Such arrangements are found, for example, in a drive-through lane of a restaurant. However, cashiers and customers at each location can frequently confuse orders or misidentify items. For example, a first order may take a longer time to prepare than a second later-placed order. Thus, the second order could accidentally be picked up by the customer who placed the first order, especially if each ordered item's packaging is similar.

Moreover, standard packaging and/or generic labels often prevent a customer from easily verifying delivery of the correct item. For example, a label such as “hamburger” does not confirm whether the cook followed custom instructions to include or exclude certain toppings. These problems are compounded when a customer represents a group of people and must deliver each item to the correct person in the group.

Methods and systems for intelligently and conveniently labeling orders are, therefore, desirable.

### BRIEF SUMMARY

Embodiments of the present invention relate generally to methods and systems for intelligently labeling an order. Preferably, the methods and systems provide an intelligent data link between “receipt” printers and “label” printers. The intelligent data link insures that information printed on an order's label matches receipt data, thereby minimizing any human error being introduced into the process. By way of example, systems may include multiple printers and multiple data links to accommodate multiple POS terminals found at typical retail establishments. For example, many quick serve restaurants have a drive-through POS terminal and multiple walk-in POS terminals, each having a receipt printer. A label printer may also be provided at each one of various kitchen stations frequently found at such restaurants.

One example embodiment is directed to a method for intelligently printing labels based on order data. The method may include receiving order data at a receipt printer, which may be communicatively connected to a point-of-sale (POS) terminal. The order data may then be processed, with reference to a plurality of pre-defined templates, to generate label data. The label data or a portion thereof may be printed at a label printer having a communicative link to the receipt printer. The order data may be processed at the receipt printer, the label printer, or a separate computing device communicatively connected to the receipt printer and the label printer.

Another example embodiment is directed to a printer adapted to implement at least a portion of the label printing method. For example, a printer is configured to include a receive port adapted to receive order data from a first external device and a send port adapted to send or forward the order data to a second external device. The send port may also be adapted to send label data, which may be generated based on the order data. The printer may also include a printing mechanism adapted to print at least a portion of the order data and/or at least a portion of the label data.

The invention may also be embodied as an order processing system, which may include, for example, a receipt printer and a label printer communicatively linked through a data network to transfer order data and/or label data from the receipt printer to the label printer. A POS terminal may be communicatively connected to the receipt printer to send order data entered by an operator of the POS terminal. The system may also include a processor adapted to generate the label data based on the order data. The processor may be embodied as part of the receipt printer, the label printer, or a separate computing device communicatively connected to the receipt printer and the label printer.

Such systems and methods for intelligently automating the order process provide a number of advantages over prior art solutions. For example, the order process is simplified, and the process results in accurate order data for a given customer. Moreover, the opportunity for human error is reduced. Customer satisfaction, speed, and reduced costs are all realized.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a first exemplary system for implementing intelligent label printer control consistent with the present invention;

FIG. 2 illustrates a second exemplary system for implementing intelligent label printer control consistent with the present invention;

FIG. 3 illustrates an exemplary embodiment of a receipt printer consistent with the present invention;

FIG. 4 illustrates an exemplary embodiment of a label printer consistent with the present invention;

FIGS. 5A-5C each illustrate an intelligent labeling method that may be implemented by the exemplary systems of FIGS. 1 and 2.

### DETAILED DESCRIPTION

In the following detailed description of various embodiments of the invention, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

The following description provides example embodiments of methods and systems for intelligently labeling an order. The methods and systems provide an intelligent data link between receipt printers and label printers. Consequently, information printed on an order's label matches receipt data and human error is reduced. Systems may include multiple printers and multiple data links to accommodate multiple POS terminals found at typical retail establishments. For example, many quick serve restaurants have a drive-through POS terminal and multiple walk-in POS terminals, each having a receipt printer. A label printer may also be provided at each one of various kitchen stations frequently found at such restaurants.

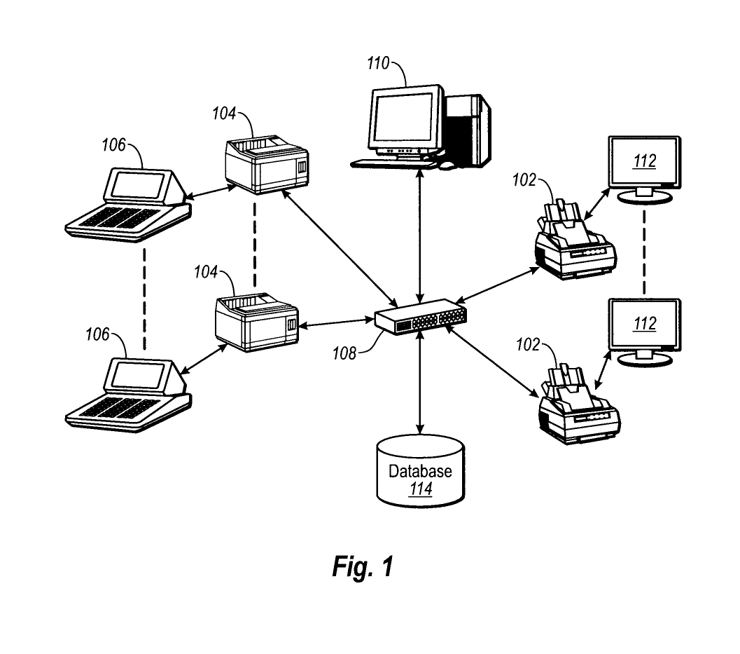

FIG. 1 shows an exemplary system comprising a plurality of label printers 102 and a plurality of receipt printers 104 for implementing intelligent label printer control. One or more of label printers 102 and receipt printers 104 may be EPSON™ TM-T88 IV printers or EPSON™ TM-L90 printers. The system also may include a plurality of POS terminals 106 adapted to process financial transactions, to receive order data input by an operator, and to send the order data to receipt printers 104. Order data can be data input by an operator, such as a customer or retailer, and/or may include automatically generated data. For example, order data may include purchase price, information about purchased items, store identity, customer identity, and/or other financial transaction information. POS terminals 106 may be kitchen display system terminals or kitchen video controllers, or may be connected to such terminals or controllers, and may each include an operator interface such as a keypad, touch screen, bar code scanner, credit card scanner, and/or voice input, among other things. In one embodiment each of receipt printers 104 may be integral with a corresponding one of POS terminals 106.

Receipt printers 104 (or POS terminals 106 with integrated receipt printers 104) may forward the order data to label printers 102. Data may be transferred between receipt printers 104 and label printers 102 via communicative links in a network. The links may be wired, wireless, or a combination of wired and wireless connections and may include a connection through a central switch or router 108. The network may be a local area network structured as a bus/tree, ring, and/or star topology implementing a network communications standard such as universal serial bus, Ethernet, token ring, token bus, asynchronous transfer mode, fibre channel, spread spectrum wireless, infrared, etc. Moreover, in one embodiment connections between receipt printers 104 and label printers 102 can be one-way and/or one-to-one connections. For example, each one of receipt printers 104 may connect to a corresponding one of label printers 102 via a separate wired or wireless link, some or all of which may be two-way links, one-way links from receipt printers 104 to label printers 102, or some combination thereof.

Label printers 102 may include hardware and/or software elements adapted to parse the order data received from receipt printers 104. Alternatively, receipt printers 104 or a computing device 110 connected to the network may parse the order data prior to its transmission to label printers 102. The order data may be interpreted or parsed with reference to pre-defined dynamically loaded selection criteria. The selection criteria may include information identifying items available for purchase at the particular retail establishment (e.g., menu items), custom selection information (e.g., no pickles, extra tomatoes, etc.), or other information, such as promotion details. The selection criteria may be programmable so that purchasable items may be added, removed, or altered. Thus, new items may be accommodated in the selection criteria as they become available, older items may be phased out, custom selection information may be added, removed, or changed, and/or customer information may be added, removed, or changed.

A display 112 may be attached to one or more of label printers 102. Displays 112 may be touch screens adapted to display label data for selection by an operator and to communicate operator selections to corresponding label printers 102. In one embodiment displays 112 may be integrated with corresponding label printers 102. Label printers 102 may be controlled via displays 112 to print a subset of label data generated from the order data. In addition, or alternatively, label printers 102 may be controlled via displays 112 to print label data in an order specified by an operator. For example if a first order precedes a second order chronologically but the second order is ready for delivery to a customer first, an operator may, via display 112, select label data corresponding to the second order to be printed sooner than label data corresponding to the first order.

The system of FIG. 1 may also include a customer database 114, which may index and record relationships between customer identification information and customer information, among other things. For example, a retail establishment may wish to track a number of purchases made, purchase totals, unique preferences, etc, associated with its customers.

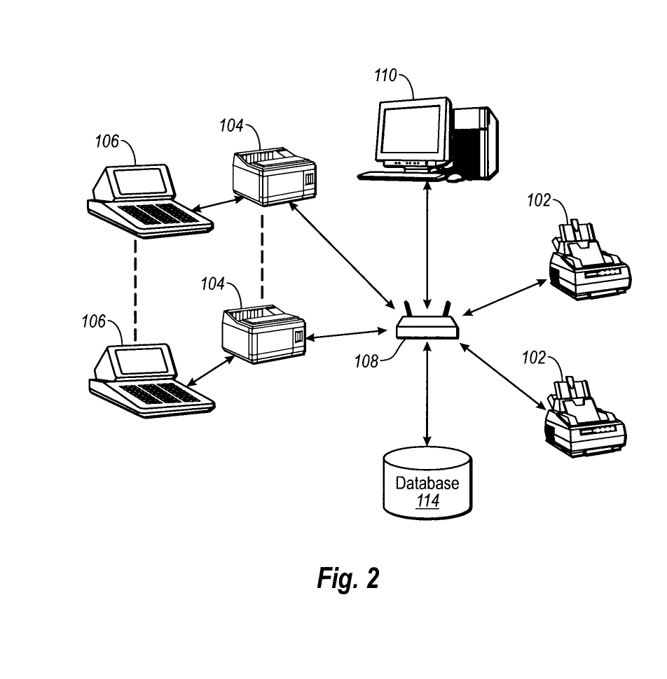

FIG. 2 shows an exemplary system like that of FIG. 1 but without displays 112. In the system of FIG. 2, operation may be similar to the system of FIG. 1, but with label printers 102 adapted to print label data according to an order of receipt. This configuration may be desirable where minimal user maintenance or intervention is preferred to, for example, save time or reduce system complexity. FIG. 2 also differs from FIG. 1 in that the network is represented as a wireless network rather than a wired network.

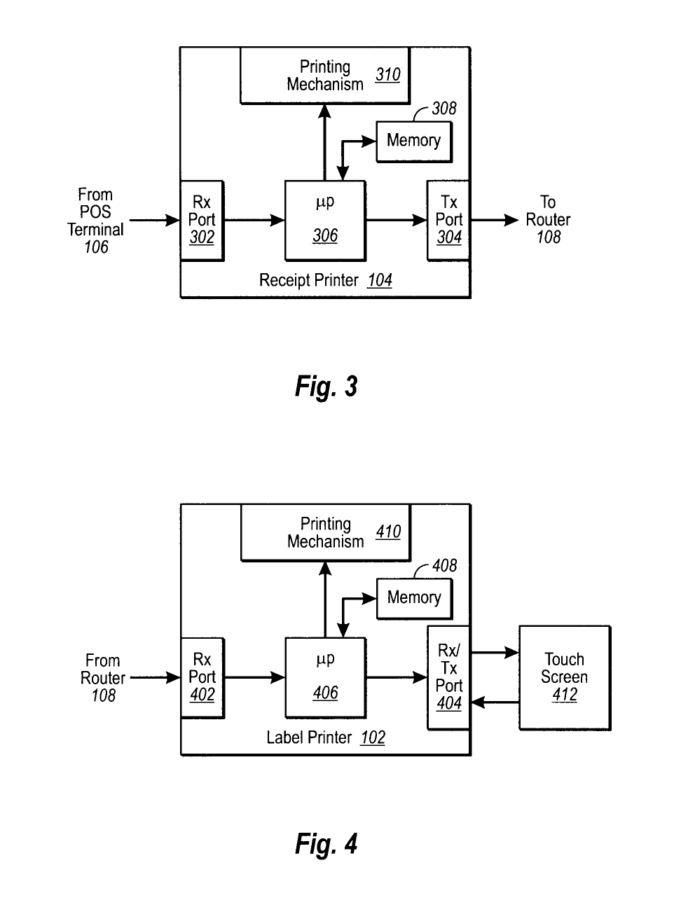

FIG. 3 shows an embodiment of one of receipt printers 104. Receipt printer 104 may include a receive (Rx) port 302, a send (Tx) port 304, a processor (μp) 306, a memory 308, and a printing mechanism 310. Receive port 302 may receive order data from one of POS terminals 106. (If receipt printer 104 is integrated with POS terminal 106 receive port 302 may be omitted.) The order data may be transferred to processor 306 where it may be processed and sent to printing mechanism 310, memory 308, and/or send port 304. In some embodiments of receipt printers 104, receive port 302 and send port 304 may be combined as a single bidirectional port.

Processor 306 may process the order data and may manage/control some or all other electronic components of receipt printer 104. Management and control operations may be handled by firmware loaded in processor 306. Processing order data may include reformatting the order data so that it is compatible with another interface such as printing mechanism 310 or send port 304. For example, a receipt may be printed by printing mechanism 310 and processor 306 may format the order data in accordance with a receipt template, e.g., a document comprising a list or table for designating a particular format for printing the order data.

Memory 308 may store receipt templates and label criteria. The receipt template and label criteria may be dynamically selectable and may be loaded via an interface such as receive port 302 or another port adapted to receive data from another device via, for example, a network connection. Dynamically selectable criteria may be stored in a configuration file formatted as, for example, an XML document.

Processor 306 may process the order data to generate label data by parsing and comparing the order data with triggers in the configuration file. Then the label data may be transferred out of receipt printer 104 to label printer 102 via send port 304. In certain embodiments, however, processor 306 may instead forward the order data without generating label data. The order data may be processed for generation of label data by another processor external to receipt printer 104. In one embodiment processor 306 may be a processor on a dual interface connectivity card, which may also include receive port 302 and send port 304.

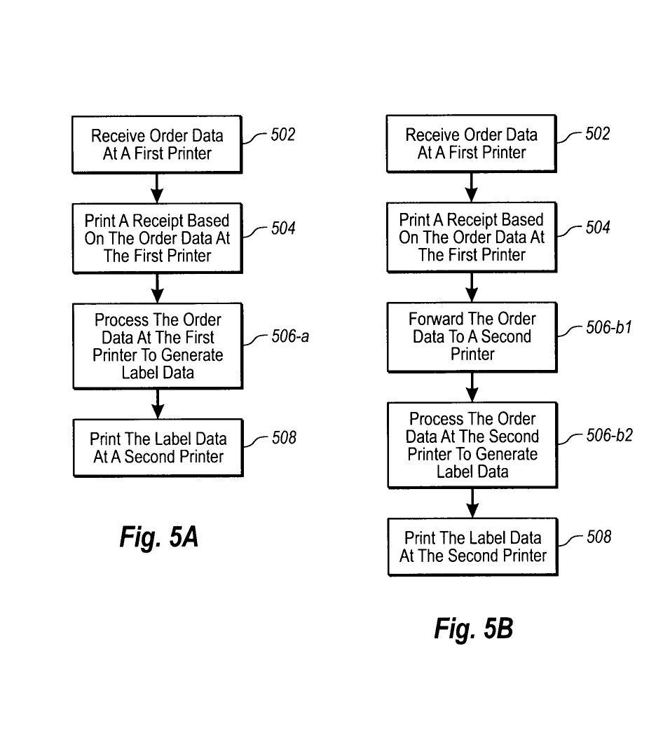

FIG. 4 shows an embodiment of one of label printers 102 and an optional touch screen 402 connected thereto. Label printer 102 may include a receive (Rx) port 402, a bidirectional send and receive (Rx/Tx) port 404, a processor (μp) 406, a memory 408, and a printing mechanism 410. Receive port 402 may receive order data transmitted over a network link by a receipt printer 104. The order data may be transferred to processor 406 where it may be processed to generate label data. The label data may be sent to printing mechanism 410, memory 408, and/or send port 404.

Processor 406 may process the order data and may manage/control some or all other electronic components of label printer 102. Management and control operations may be handled by firmware loaded in processor 406. As discussed above with reference to FIG. 3, processing order data may include reformatting the order data so that it is compatible with another interface such as printing mechanism 410 or bidirectional portal 404. For example, a label may be printed by printing mechanism 410 and processor 406 may format the order data in accordance with dynamically selectable label criteria.

Memory 408 may store the label criteria, among other things. The label criteria may be dynamically selectable and may be loaded via an interface such as receive port 402 or another port adapted to receive data from another device via, for example, a network connection. The dynamically selectable label criteria may be provided in the form of a configuration file, which may be formatted as, for example, an XML document having options, templates, and/or rules. The rules may include triggers and actions. The following is an exemplary format that an option portion of the configuration file may have:

<UpdateFlash> BOOLEAN </UpdateFlash>
<DebugIP>nnn.nnn.nnn.nnn</DebugIP>
<RemoteIP1> nnn.nnn.nnn.nnn </RemoteIP1>
<RemoteIP2> nnn.nnn.nnn.nnn </RemoteIP2>
<DebugOutput>BOOLEAN</DebugOutput>
<OrientLocal> BOOLEAN </OrientLocal>
<OrientRemote> BOOLEAN </OrientRemote>
<NumLineFeed>n</NumLineFeed>
<PrintLogo> BOOLEAN </PrintLogo>
<LogoStart>n</LogoStart>
<LogoStop>n</LogoStop>
<PrintBanner> BOOLEAN </PrintBanner>
<BannerStart>n</BannerStart>
<BannerStop>n</BannerStop>
<Banner>Banner Text </Banner>

The following is an exemplary format that a template portion of the configuration file may have:

```
<UpdateFlash>BOOLEAN</UpdateFlash>
<Templates>
    <Template>
        <Item>
            <Key>Match Key</Key>
            <Text>Representation</Text>
        </Item>
        <Item>
            <Key>Match Key</Key>
            <Text>Representation</Text>
        </Item>
    </Template>
    <Template_n>
        <Item>
                <Key>Match Key</Key>
                <Text>Representation</Text>
        </Item>
        <Item>
                <Key>Match Key</Key>
                <Text>Representation</Text>
        </Item>
    </Template_n>
</Templates>
```

Finally, a rule portion of the configuration file may have the following exemplary format:

```
<UpdateFlash>BOOLEAN</UpdateFlash>
<Rules>
    <Search>
        <Pipes>in,temp</Pipes>
        <DefaultPrint>BOOLEAN</DefaultPrint>
        <Rule>
            <Trigger>Template Match Key{x} {y}</Trigger>
            <Action> Template Representation{x} {y}</Action>
        </Rule>
        <Rule>
            <Trigger> Template Match Key {x} {y}</Trigger>
            <Trigger n>Template Match Key {n} {m}</Trigger n>
              <Action> Template Representation{x} {y} </Action>
            <Action n> Template Representation {n} {m}</Action n>
        </Rule>
    </Search>
    <Search n>
        <Pipes>temp n,out</Pipes>
        <DefaultPrint>BOOLEAN</DefaultPrint>
        <Rule>
            <Trigger> Template Match Key {x} {y}</Trigger>
            <Action>> Template Representation </Action>
        </Rule>
        <Rule>
            <Trigger>Template{x} {y}</Trigger>
            <Trigger n>Template{n} {m}</Trigger n>
              <Action> Template Representation{x} {y} </Action>
            <Action n> Template Representation {n} {m}</Action n>
        </Rule>
    </Search n>
    </Rules>
```

Processor 406 may process the order data to generate label data by parsing and comparing the order data with configuration file templates (denoted as “triggers” in the rule portion above). For example, a configuration file may include, in its template portion, text representations of various items that can be purchased and/or custom characteristics of such items. The rule portion may reference (e.g., using match key tags) the template portion of the configuration file to define triggers that will cause an action to take place. As a result, when order data matches text data listed in the template portion of the configuration file, a particular corresponding action, e.g., generation of corresponding label data, may take place. As discussed previously, the template portion may be dynamically selectable so that, for example, new custom characteristics may be added at any time. Access to templates may be restricted by, for example, password protecting the configuration file.

As one example of how order data may be processed, the configuration file may include match keys corresponding to “hamburger” and “no pickles” in the template portion and a rule corresponding to each of the match keys in the rule portion. Thus, if an order for a hamburger with no pickles is placed by a customer the rules of the configuration file will operate to compare the order data with one or more of the templates in the configuration file. If “hamburger” and “no pickles” are recognized as matching a template in the configuration file, corresponding label data may be generated.

Label data may include a trade name for an item. For example, if the order data includes “hamburger,” the corresponding label data may be a trade name such as “Joe's Burger.” In addition, label data may be the same as or very similar to its corresponding order data. For example, if the order data includes “no pickles,” the corresponding label data may be the same data, i.e., “no pickles,” or an abbreviation thereof, e.g., “NP.” Moreover, although a single ordered item has been described in this example, label data may include data corresponding to multiple ordered items.

Instead of generating label data, processor 406 may instead receive label data from an external device via receive port 402. Thus, the label data may be generated by another processor, e.g., processor 306 of receipt printer 104, or by computing device 110, which may be positioned in the network so as to receive order data from one or more of receipt printers 104, process the order data to generate label data, and transmit the label data to one or more of label printers 104. Moreover, receive port 402 and bidirectional port 404 of label printer 102 may be combined as a single bidirectional input/output port in certain embodiments. Once label data has been generated or received, it may be printed via printing mechanism 410.

Input and output devices, such as touch screen 412, may be integrated with or communicatively connected with label printer 104. Touch screen 412 or a similar device may permit an operator to select various options, such as which label data to include on a particular label or an order for printing labels. For example, label printer 102 may receive label print jobs in a queue or spool and the order of print jobs may need to be rearranged to allow, for example, for different order preparation speeds. Alternatively, to reduce complexity or a likelihood of user error, touch screen 412 may be omitted and label printer 102 may be adapted to print labels according to an order of receipt, i.e., first come first serve.

Customer information may be stored in memory 308 of receipt printer 104 and/or memory 408 of label printer 102. Customer information stored in memories 308 and/or 408 may reflect customer information stored in customer information database 114, which may be communicatively attached to printers 102 and 104. In this manner, printers 102 and/or 104 may print receipts and/or labels that include updated customer information, such as promotional items for a given customer based on buying habits, etc. For example, a receipt or label may include a coupon for the customer based on buying habits and the like.

In one embodiment, receipt printer 104 may receive customer identifying information from POS terminal 106. The customer identification may be transferred to customer information database 114 to retrieve information associated with the customer identification. Alternatively, POS terminal 106 may interface with customer information database 114, receive customer information, and forward the information to receipt printer 104. In yet another embodiment, customer information may be forwarded by receipt printer 104 to label printer 102 with or separately from the order data or label data, as the case may be, and label printer 102 may be adapted to interface with customer information database 114 to retrieve information based on the customer information. Once the appropriate information has been retrieved or received by receipt printer 104 or label printer 102, the information (such as a promotion, coupon, etc.) may be printed on a receipt or label to be given to the customer.

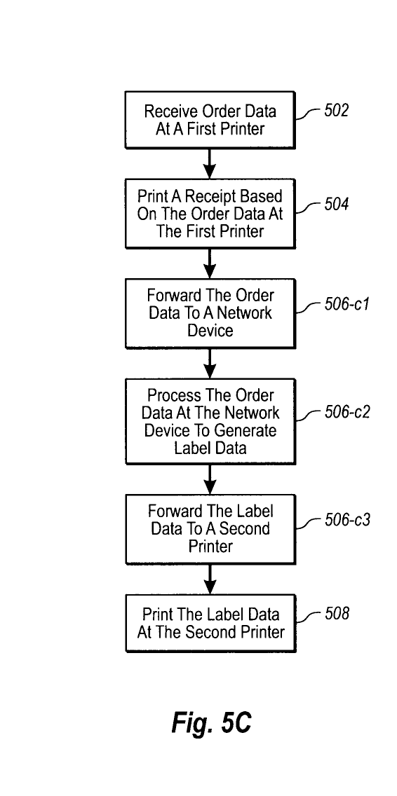

FIGS. 5A-5C show different methods that may be implemented by either of the systems in FIGS. 1 and 2 to intelligently generate and print labels. In FIG. 5A, order data is first received at a first printer, such as one or more of receipt printers 104 (stage 502). A receipt may be printed at the first printer based on the received order data (stage 504). For example, the first printer at which order data is received may format the order data in accordance with a receipt template that may include, for example, purchase price, information on purchased items, store identity, customer identity, and/or other financial transaction information. Next, the order data may be processed at the first printer to generate label data (stage 506-a). The label data may be generated as described above with reference to FIGS. 3 and 4. For example, the order data may be parsed and compared to dynamically selectable label criteria, which may be provided in the form of a configuration file having options, templates, and/or rules. Once generated, the label data may be printed at a second printer, such as one or more of label printers 102, which is communicatively linked to the first printer (stage 508).

The method of FIG. 5B may be similar to that of FIG. 5A, but instead of processing order data at the first printer, the order data may be processed at the second printer. Thus, after receiving order data (stage 502) and printing a receipt (stage 504), the order data may be forwarded to a second printer, such as one or more of label printers 102 (stage 506-b1), where it may be processed to generate label data (stage 506-b2). As in FIG. 5A, the label data may then be printed at the second printer (stage 508). In this exemplary method, a memory portion of the second printer may be loaded with a configuration file having dynamically selectable criteria and the processor of the second printer may be equipped to parse the order data and compare it with the criteria.

As a third exemplary method, shown in FIG. 5C, order data may be processed at a network device connected to the first and second printers. After receiving order data (stage 502) and printing a receipt (stage 504), the order data may be forwarded from the first printer to a network device, such as computing device 110, communicatively connected thereto, for processing (stage 506-c1). The network device may process the order data to generate label data in accordance with the techniques described above (stage 506-c2) and the label data may be forwarded to the second printer (stage 506-c3) for printing (stage 508).

Stages of FIGS. 5A-5C may be modified in various ways. For example, the order of stages may be varied, certain stages may be omitted and/or additional stages may be added. The stages may be implemented or may occur at the same frequency or at differing frequencies. For example, printing a receipt at the first printer (stage 504) may be omitted from each of the methods or may performed after one or more subsequent stages have been performed. Moreover, in other exemplary methods, stages from each of the methods of FIGS. 5A-5C may be included. For example, at least some of the order data may be processed at the first printer, the network device, and/or the second printer. Thus, portions of the label data may be generated at a combination of the first printer, the network device, and/or the second printer.

In addition, methods in each of FIGS. 5A-5C may optionally include processing the order data to identify a customer based on the order data and updating program data associated with the customer. Customer information may be stored in a remote customer information database. The information associated with the customer identified by the order data may be updated to include portions of the order data or other information related to the order data, such as purchase amount, purchased items, etc. Each exemplary method may also include receiving, at the second printer, a user selection of a portion of the label data to be printed. For example, the second printer may be equipped with an input/output device such as a touch screen, which may display a default label to be printed. The second printer may receive, via the touch screen, a user selection of which portions of the default label to print and/or which portions to omit. In addition, entry of additional information to be printed with the label data may be received via the touch screen.

Example embodiments of methods and systems for intelligently labeling an order have been described. Although embodiments have been described for use in a restaurant scenario, the principles may be applied in other similar contexts where multiple printers are communicatively linked.

Exemplary embodiments may comprise a special purpose or general-purpose computer including various computer hardware implementations. Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for printing label data based on order data, the method comprising:
receiving the order data at a first printer;
processing the order data to generate label data; and
printing at least a portion of the label data at a second printer having a communicative link to the first printer.

2. The method as recited in claim 1, wherein the first printer processes the order data to generate the label data.

3. The method as recited in claim 1, further comprising:
forwarding the order data from the first printer to the second printer over the communicative link,
wherein the second printer processes the order data to generate the label data.

4. The method as recited in claim 1, further comprising:
receiving, at the second printer, a user selection of a portion of the label data to be printed.

5. The method as recited in claim 1, wherein processing the order data includes comparing the order data to a plurality of pre-defined templates.

6. The method as recited in claim 5, wherein the pre-defined templates are user programmable.

7. The method as recited in claim 5, wherein the pre-defined templates are stored in an XML document.

8. The method as recited in claim 1, further comprising:
printing a receipt based on the order data at the first printer.

9. The method as recited in claim 1, wherein the communicative link is a one-way link from the first printer to the second printer.

10. The method as recited in claim 1, wherein the order data is received at the first printer from a POS terminal adapted to process financial transactions.

11. The method as recited in claim 1, wherein processing the order data includes identifying a customer based on the order data and updating customer data associated with the customer.

12. A printer comprising:
a receive port adapted to receive order data from a first device external to the printer;
a send port adapted to send at least one of the order data and label data that is generated based on the order data to a second device external to the printer; and
a printing mechanism adapted to print at least a portion of the order data and/or at least a portion of the label data.

13. The printer as recited in claim 12, wherein the second device is adapted to process the order data sent by the printer to generate the label data.

14. The printer as recited in claim 12, further comprising a processor adapted to process the order data to generate the label data.

15. The printer as recited in claim 14, wherein the processor is adapted to generate the label data by comparing the order data to a plurality of pre-defined templates.

16. The printer as recited in claim 15, wherein the pre-defined templates are user programmable.

17. The printer as recited in claim 15, wherein the pre-defined templates are stored in an XML document.

18. The printer as recited in claim 15, wherein the processor is further adapted to identify a customer based on the order data and update customer data associated with the customer.

19. A order processing system comprising:
a POS terminal adapted to receive and send order data;
a receipt printer communicatively connected to the POS terminal and adapted to receive the order data and to print a receipt based on the order data;
a processor adapted to generate label data based on the order data;
a data network including a communicative link adapted to transfer at least one of the order data and the label data from the receipt printer to the label printer;
a label printer adapted to receive the data from the receipt printer and to print at least a portion of the label data.

20. The system as recited in claim 19, wherein the processor is integrated with at least one of: the receipt printer, the label printer, and a computing device communicatively connected to the data network.
